(19) United States
(12) Patent Application Publication
(10) Pub. No.: US 2025/0226402 A1
(43) Pub. Date: Jul. 10, 2025

(54) SOLID-STATE BATTERIES WITH ALUMINUM-BASED ANODES

(71) Applicants: Novelis Inc., Atlanta, GA (US); Georgia Tech Research Corporation, Atlanta, GA (US)

(72) Inventors: Matthew McDowell, Atlanta, GA (US); Rajesh Gopalaswamy, Alpharetta, GA (US); Daehoon Kang, Canton, GA (US); Yuhgene Liu, Atlanta, GA (US); Diptarka Majumdar, Cumming, GA (US); Congcheng Wang, Atlanta, GA (US)

(73) Assignees: Novelis Inc., Atlanta, GA (US); Georgia Tech Research Corporation, Atlanta, GA (US)

(21) Appl. No.: 18/853,884

(22) PCT Filed: Apr. 7, 2023
(86) PCT No.: PCT/US2023/017867

§ 371 Date: Oct. 3, 2024

Related U.S. Application Data
(60) Provisional application No. 63/362,722, filed on Apr. 8, 2022.

(51) Int. Cl. H01M 4/46; H01M 4/02; H01M 4/40; H01M 10/0525; H01M 10/0562; H01M 10/0585

(52) U.S. Cl. CPC H01M 4/463; H01M 4/405; H01M 10/0525; H01M 10/0562; H01M 10/0585; H01M 2004/021; H01M 2300/0077

(57) ABSTRACT

Described herein are solid-state electrochemical cells incorporating a solid-state electrolyte and aluminum as an anode active material. The use of aluminum as an anode active material can drive an increase in energy density and specific energy as compared to cells using conventional lithium-ion anode materials (e.g., graphite). Pairing an aluminum anode with a solid-state electrolyte can further provide for improved safety in secondary cells as compared to cells using lithium metal anodes for less complex manufacturing compared to cells using liquid electrolytes or wet processed anode materials.

### REFERENCE TO RELATED APPLICATION

This application claims the benefit of and priority to U.S. Provisional Patent Application No. 63/362,722, filed on Apr. 8, 2022, and entitled SOLID-STATE BATTERIES WITH ALUMINUM-BASED ANODES, the content of which is hereby incorporated by reference in its entirety.

### FIELD

The present disclosure relates to metallurgy generally and more specifically to solid-state batteries containing aluminum-based anode active materials.

### BACKGROUND

Conventional lithium-ion batteries generally include a cathode, an anode, and a separator soaked with an electrolyte between them. Current collectors on the cathode side and the anode side are used to conduct electrical current between the cathode and the anode, while the electrolyte allows lithium ions to transport between the cathode and the anode. Due to the potentials involved, copper is generally used as an anode current collector and aluminum is generally used as the cathode current collector. Lithium metal oxides, like lithium cobalt oxide, are commonly used as lithium-ion battery cathodes, and graphite is commonly used as lithium-ion battery anodes.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

In various aspects, described herein are solid-state batteries or electrochemical cells. The solid-state batteries described herein include aluminum-based anode materials, which are useful as alkali metal alloying anodes and distinct from anodes used in conventional lithium-ion and solid-state batteries. Aluminum-based alkali metal alloying anodes may exhibit considerably higher lithium capacity than conventional anode materials, like graphite. For example, aluminum-based alkali metal alloying anodes may incorporate lithium atoms into the crystalline matrix of the aluminum, which means that more lithium can be incorporated per unit volume than a comparable volume of graphite, where lithium atoms are intercalated and accommodated between graphite layers. In this way, the size and/or mass of an anode can be reduced compared to a conventional graphite anode while maintaining or even increasing overall capacity. In some examples, the solid-state batteries described herein may include an anode that exhibits a specific capacity of from 300 mAh/g to 1000 mAh/g, such as from 300 mAh/g to 350 mAh/g, from 350 mAh/g to 400 mAh/g, from 400 mAh/g to 450 mAh/g, from 450 mAh/g to 500 mAh/g, from 500 mAh/g to 550 mAh/g, from 550 mAh/g to 600 mAh/g, from 600 mAh/g to 650 mAh/g, from 650 mAh/g to 700 mAh/g, from 700 mAh/g to 750 mAh/g, from 750 mAh/g to 800 mAh/g, from 800 mAh/g to 850 mAh/g, from 850 mAh/g to 900 mAh/g, from 900 mAh/g to 950 mAh/g, or from 950 mAh/g to 1000 mAh/g.

Further, the solid-state batteries described herein include a solid-state electrolyte, which is distinct from and provides a number of advantages over conventional liquid electrolytes. The combination of aluminum-based anodes and solid-state electrolytes can further be advantageous by reducing or eliminating solution or liquid processing during various manufacturing steps, as both solid-state electrolytes and aluminum-based anodes can be assembled as solid materials, together with prepared cathode materials, to create a solid-state battery.

In some examples, a solid-state battery may comprise an anode, such as an anode comprising aluminum as an anode active material, a cathode, and a solid-state electrolyte between the anode and the cathode. For example, the anode may comprise an aluminum-based alkali metal alloying anode, such as where the alkali metal is lithium. Optionally, the anode comprises an aluminum alloy or a recycled-content aluminum alloy. Use of recycled-content aluminum alloys may be useful for increasing the solid-state battery's sustainability or reducing the overall carbon footprint associated with the solid-state battery, for example.

In examples, the anode may comprise or be present in the form of a foil, such as an aluminum-based multi-component foil. In some examples, the anode has a thickness of from 5 μm to 60 μm, such as from 5 μm to 10 μm, from 10 μm to 15 μm, from 15 μm to 20 μm, from 20 μm to 25 μm, from 25 μm to 30 μm, from 30 μm to 35 μm, from 35 μm to 40 μm, from 40 μm to 45 μm, from 45 μm to 50 μm, from 50 μm to 55 μm, or from 55 μm to 60 μm.

Optionally, the aluminum-based multi-component foil may comprise aluminum or an aluminum alloy and one or more of silicon, tin, indium, gallium, antimony, lead, nickel, copper, carbon, germanium, zinc, or silver. It will be appreciated that an aluminum-based anode may undergo a volume change during uptake and release of lithium; these non-aluminum elements may enhance the ability of aluminum to be used as an alloying anode, such as by providing structural integrity and/or a conductive base to the alloying anode. In some examples, the anode comprises a foil including from 40 wt. % to 99 wt. % aluminum or an aluminum alloy and from 30 wt. % to 60 wt. % of one or more of silicon, tin, indium, gallium, antimony, lead, nickel, copper, carbon, germanium, zinc, or silver. For example, the anode may comprise aluminum or an aluminum alloy in an amount from 40 wt. % to 45 wt. %, from 45 wt. % to 50 wt. %, from 50 wt. % to 55 wt. %, from 55 wt. % to 60 wt. %, from 60 wt. % to 65 wt. %, from 65 wt. % to 70 wt. %, from 70 wt. % to 75 wt. %, from 75 wt. % to 80 wt. %, from 80 wt. % to 85 wt. %, from 85 wt. % to 90 wt. %, from 90 wt. % to 95 wt. %, or from 95 wt. % to 99 wt. %. Optionally, the anode may comprise one or more of silicon, tin, indium, gallium, antimony, lead, nickel, copper, carbon, germanium, zinc, or silver in a total amount from 30 wt. % to 35 wt. %, from 35 wt. % to 40 wt. %, from 40 wt. % to 45 wt. %, from 45 wt. % to 50 wt. %, from 50 wt. % to 55 wt. %, or from 55 wt. % to 60 wt. %. In some examples, the aluminum alloy may be a brazing alloy,

In some examples, the anode comprises a composite foil, such as including a first plurality of aluminum or aluminum alloy particles and a second plurality of particles selected from at least one of metal particles or non-metal particles. Useful metal or non-metal particles may include elements other than aluminum, such as one or more of silicon, tin, indium, gallium, antimony, lead, nickel, copper, carbon, germanium, zinc, or silver.

Any suitable solid-state electrolyte may be used with the solid-state batteries described herein. For example, the solid-state electrolyte may be or comprise an inorganic solid electrolyte, though other solid-state electrolytes may be used, such as a polymer solid electrolyte or a gel-polymer electrolyte. Optionally, the solid-state electrolyte comprises a lithium argyrodite material, Li₆PS₅Cl, a lithium super ionic conductor (LISICON), a doped garnet material, Li₇La₃Zr₂O₁₂ (LLZO), Li₁₀GeP₂S₁₂, Li₁₀SnP₂S₁₂, lithium phosphorus sulfide (Li₃PS₄), or lithium phosphorus oxynitride (LIPON). The solid-state electrolyte may have any suitable thickness. In examples, the solid-state electrolyte may have a thickness of from about 10 μm to about 300 μm, such as from 10 μm to 20 μm, from 20 μm to 30 μm, from 30 μm to 40 μm, from 40 μm to 50 μm, from 50 μm to 75 μm, from 75 μm to 100 μm, from 100 μm to 125 μm, from 125 μm to 150 μm, from 150 μm to 175 μm, from 175 μm to 200 μm, from 200 μm to 225 μm, from 225 μm to 250 μm, from 250 μm to 275 μm, or from 275 μm to 300 μm.

Any suitable cathode can be used with the solid-state batteries described herein. For example, the cathode may comprise an alkali ion host material or an alkali metal-transition metal oxide cathode active material. Optionally, the cathode may comprise lithium nickel manganese cobalt oxide, lithium nickel cobalt aluminum oxide, lithium manganese oxide, lithium iron phosphate, lithium cobalt oxide, conversion cathodes, FeS₂, FeF₃, sulfur-based cathodes, or sulfur.

Other suitable components can optionally be included in the solid-state batteries described herein. For example, a solid-state battery may further comprise one or more of: a cathode current collector in contact with the cathode; or an anode current collector in contact with the anode. Optionally, the anode current collector and/or the cathode current collector comprises a protected aluminum alloy foil. Optionally, the anode current collector comprises a copper foil.

In some examples, the anode, solid-state electrolyte, and the cathode are in a stack with an applied pressure between them. For example, a stack pressure applied between the anode and the cathode may be from about 0.1 MPa to about 30 MPa, such as from 0.1 MPa to 0.5 MPa, from 0.5 MPa to 1 MPa, from 1 MPa to 2 MPa, from 2 MPa to 3 MPa, from 3 MPa to 4 MPa, from 4 MPa to 5 MPa, from 5 MPa to 7.5 MPa, from 7.5 MPa to 10 MPa, from 10 MPa to 12.5 MPa, from 12.5 MPa to 15 MPa, from 15 MPa to 17.5 MPa, from 17.5 MPa to 20, from 20 MPa to 22.5 MPa, from 22.5 MPa to 25 MPa, from 25 MPa to 27.5 MPa, from 27.5 MPa to 30 MPa.

In another example, another component that may optionally be included is an interface material. For example, a solid-state battery may further comprise an interface material between the anode and the solid-state electrolyte. Optionally, the interface material comprises a solid-electrolyte interphase, an artificial solid-electrolyte interphase, a polymer coating, a carbon coating, or an inorganic coating.

In another aspect, methods of making solid-state batteries or electrochemical cells are described herein. An example method of this aspect comprises providing an anode, such as an anode comprising aluminum as an anode active material, providing a cathode, and positioning a solid-state electrolyte between the anode and the cathode. Methods of this aspect may comprise or further comprise one or more of: contacting the anode with an anode current collector or contacting the cathode with a cathode current collector.

Optionally, providing the anode comprises preparing an aluminum-based multi-component foil, such as an aluminum-based multi-component foil that comprises aluminum or an aluminum anode and one or more of silicon, tin, indium, gallium, antimony, lead, nickel, copper, carbon, germanium, zinc, or silver.

Various methods can be used for preparing the aluminum-based multi-component foil. In some examples, preparing the aluminum-based multi-component foil comprises casting an aluminum-based multi-component product comprising aluminum and one or more of silicon, tin, indium, gallium, antimony, lead, nickel, copper, carbon, germanium, zinc, or silver to create an aluminum-based multi-component product, and rolling the aluminum-based multi-component product into a foil. In some examples, preparing the aluminum-based multi-component foil comprises obtaining a powder mixture of aluminum and one or more of silicon, tin, indium, gallium, antimony, lead, nickel, copper, carbon, germanium, zinc, or silver, and subjecting the powder mixture to a laser powder bed fusion process to create aluminum-based multi-component product. In some examples, preparing the aluminum-based multi-component foil comprises accumulative roll bonding aluminum or an aluminum alloy and an amount of one or more of silicon, tin, indium, gallium, antimony, lead, nickel, copper, carbon, germanium, zinc, or silver to create aluminum-based multi-component product. In some examples, preparing the aluminum-based multi-component foil comprises, forming a micro-porous or nano-porous aluminum-based multi-component product using powder metallurgy, additive manufacturing, metallic foams, forming perforations by laser or deep etching, de-alloying (e.g., chemical de-alloying), or other methods. Optionally, preparing the aluminum-based multi-component foil comprises or further comprises rolling the aluminum-based multi-component product into a foil.

Other objects and advantages will be apparent from the following detailed description of non-limiting examples.

### BRIEF DESCRIPTION OF THE FIGURES

The specification makes reference to the following appended figures, in which use of like reference numerals in different figures is intended to illustrate like or analogous components.

FIG. 1 provides a schematic overview of an example method for making a rolled aluminum alloy product.

FIG. 2 provides a schematic illustration of an example solid-state electrochemical cell including an anode comprising aluminum as an anode active material.

FIG. 3 provides a schematic illustration of an example solid-state electrochemical cell including an anode comprising aluminum as an anode active material and a protected aluminum anode current collector.

FIG. 4 provides data showing example cell cycling data for a first example solid-state electrochemical cell.

FIG. 5 provides data showing cycling capacity data for a first example solid-state electrochemical cell.

FIG. 6 provides data showing Coulombic efficiency data for a first example solid-state electrochemical cell.

FIG. 7 provides data showing example cell cycling data for a second example solid-state electrochemical cell.

FIG. 8 provides data showing cycling capacity data for a second example solid-state electrochemical cell.

FIG. 9 provides data showing Coulombic efficiency data for a second example solid-state electrochemical cell.

FIG. 10 provides data showing example cell cycling data for an example reference half-cell employing a liquid electrolyte.

FIG. 11 provides data showing cycling capacity data for an example reference half-cell employing a liquid electrolyte.

FIG. 12 provides data showing Coulombic efficiency data for an example reference half-cell employing a liquid electrolyte.

### DETAILED DESCRIPTION

Described herein are solid-state electrochemical cells incorporating a solid-state electrolyte and aluminum materials as the anode active material. The use of aluminum as an anode active material can drive an increase in energy density and specific energy as compared to cells using conventional anode materials (e.g., graphite), improved safety in secondary cells as compared to cells using lithium metal anodes or compared to cells using liquid electrolytes, and avoids, at least for the anode side, wet processing, use of liquid solvents during manufacturing, and use of liquid electrolytes.

The aluminum anode active material can comprise an alkali metal alloying anode. For example, lithium can alloy with aluminum at low potentials, where lithium ions can be reduced and incorporated into the bulk of the aluminum material as an alloy. The aluminum used for the anode active material can be a foil (e.g., a composite foil or an alloy foil), such as a foil that comprises aluminum or an aluminum alloy and optionally including one or more other elements in an amount from 0.5 mol. % to 50 mol. %, such as silicon, tin, indium, gallium, antimony, lead, nickel, copper, zinc, carbon, germanium, silver, etc. The foil may be or comprise a eutectic alloy, a solid solution alloy, a mixed metal system, or a composite particle system. As described herein, foils can be processed using metal casting and rolling processes, but other techniques can be used to prepare foils including powder-based sintering or laser melting processes, such as laser powder bed fusion techniques. Further, foils can be prepared to have an engineered structure, such as by using powder metallurgy techniques, forming a micro-porous or nano-porous structure by additive manufacturing, using metallic foams, forming perforations by laser or deep etching, de-alloying (e.g., chemical de-alloying), or other methods. In some examples, a metal product prepared by a powder-based or engineering process can be subjected to rolling to at least partially consolidate and/or make a foil from the metal product.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference is made aluminum to alloys identified by AA numbers and other related designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, a plate generally has a thickness of greater than about 15 mm. For example, a plate may refer to an aluminum product having a thickness of greater than about 15 mm, greater than about 20 mm, greater than about 25 mm, greater than about 30 mm, greater than about 35 mm, greater than about 40 mm, greater than about 45 mm, greater than about 50 mm, or greater than about 100 mm.

As used herein, a shate (also referred to as a sheet plate) generally has a thickness of from about 4 mm to about 15 mm. For example, a shate may have a thickness of about 4 mm, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an aluminum product having a thickness of less than about 4 mm. For example, a sheet may have a thickness of less than about 4 mm, less than about 3 mm, less than about 2 mm, less than about 1 mm, less than about 0.5 mm, or less than about 0.3 mm (e.g., about 0.2 mm). As used herein, foils comprise a subset of sheets and generally have thicknesses less than about 200 μm. In some examples, foils can have thicknesses of from about 10 μm to about 200 μm, such as about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, or 200 μm.

Reference may be made in this application to alloy temper or condition. For an understanding of the alloy temper descriptions most commonly used, see “American National Standards (ANSI) H35 on Alloy and Temper Designation Systems.” An F condition or temper refers to an aluminum alloy as fabricated. An O condition or temper refers to an aluminum alloy after annealing. An Hxx condition or temper, also referred to herein as an H temper, refers to a non-heat treatable aluminum alloy after cold rolling with or without thermal treatment (e.g., annealing). Suitable H tempers include HX1, HX2, HX3 HX4, HX5, HX6, HX7, HX8, or HX9 tempers. A T1 condition or temper refers to an aluminum alloy cooled from hot working and naturally aged (e.g., at room temperature). A T2 condition or temper refers to an aluminum alloy cooled from hot working, cold worked and naturally aged. A T3 condition or temper refers to an aluminum alloy solution heat treated, cold worked, and naturally aged. A T4 condition or temper refers to an aluminum alloy solution heat treated and naturally aged. A T5 condition or temper refers to an aluminum alloy cooled from hot working and artificially aged (at elevated temperatures). A T6 condition or temper refers to an aluminum alloy solution heat treated and artificially aged. A T7 condition or temper refers to an aluminum alloy solution heat treated and artificially overaged. A T8x condition or temper refers to an aluminum alloy solution heat treated, cold worked, and artificially aged. A T9 condition or temper refers to an aluminum alloy solution heat treated, artificially aged, and cold worked. A W condition or temper refers to an aluminum alloy after solution heat treatment.

As used herein, terms such as “cast metal product,” “cast product,” “cast aluminum alloy product,” and the like are interchangeable and refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C. As used herein, the meaning of “ambient conditions” can include temperatures of about room temperature, relative humidity of from about 20% to about 100%, and barometric pressure of from about 975 millibar (mbar) to about 1050 mbar. For example, relative humidity can be about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, or anywhere in between. For example, barometric pressure can be about 975 mbar, about 980 mbar, about 985 mbar, about 990 mbar, about 995 mbar, about 1000 mbar, about 1005 mbar, about 1010 mbar, about 1015 mbar, about 1020 mbar, about 1025 mbar, about 1030 mbar, about 1035 mbar, about 1040 mbar, about 1045 mbar, about 1050 mbar, or anywhere in between.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt. %).

As used herein, the meaning of “a,” “an,” and “the” includes singular and plural references unless the context clearly dictates otherwise.

In the following examples, aluminum alloy products and their components may be described in terms of their elemental composition in weight percent (wt. %) or atomic percent (at. %) or mole percent (mol. %). In each alloy, the remainder is aluminum, with a maximum wt. % of 1% for the sum of all impurities (e.g., less than or about 0.15%, 0.25%, 0.5%, 0.75%, or 1%). In some examples, impurities refer to non-specified elemental components besides those specifically indicated for a particular alloy or composition. In some examples, aluminum alloys or composites are described herein that include aluminum and one or more other components, which may be present in amounts up to 30 mol. %, 40 mol. % or 50 mol. %.

Incidental elements, such as grain refiners and deoxidizers, or other additives may be present in the invention and may add other characteristics on their own without departing from or significantly altering the alloy described herein or the characteristics of the alloy described herein.

Unavoidable impurities, including materials or elements, may be present in an alloy in minor amounts due to inherent properties of aluminum or leaching from contact with processing equipment. Some alloys, as described, may contain no more than about 0.25 wt. % of any element besides the alloying or component elements, incidental elements, and unavoidable impurities.

### Methods of Producing Aluminum Alloy Products

The aluminum alloy products described herein, such as aluminum alloy foils or aluminum-based foils, can be prepare using suitable methods. For example, aluminum alloys may be cast, homogenized, hot-rolled, cold-rolled, heat treated, formed, or the like to generate aluminum alloy products.

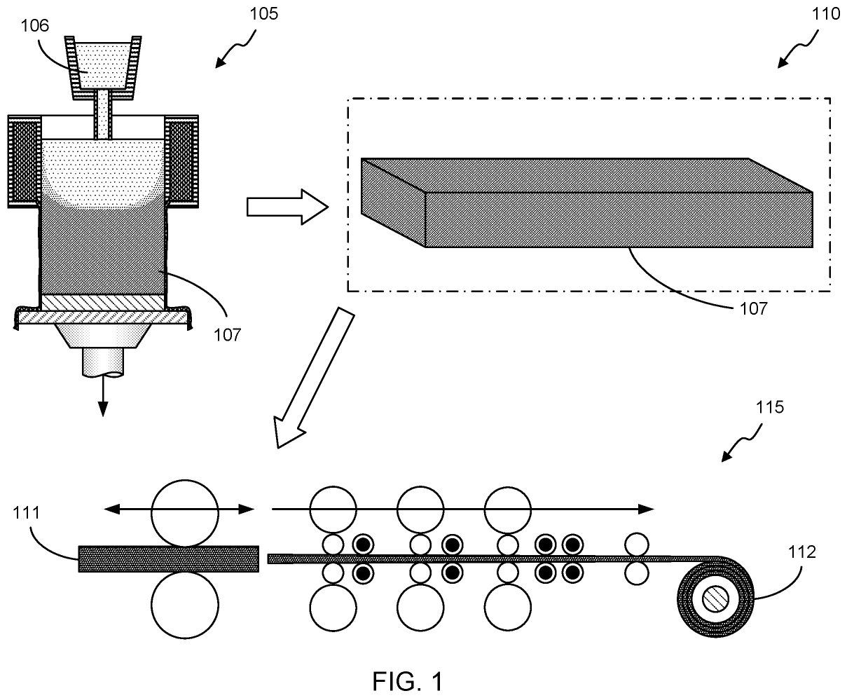

FIG. 1 provides an overview of an example method of making an aluminum alloy product. The method of FIG. 1 begins at 105, where an aluminum alloy 106 is cast to form a cast aluminum alloy product 107, such as an ingot or other cast product. At 110, the cast aluminum alloy product 107 is homogenized to form a homogenized aluminum alloy product 111. At 115, the homogenized aluminum alloy product 111 is subjected to one or more hot rolling passes and/or one or more cold rolling passes to form a rolled aluminum alloy product 112, which may correspond to an aluminum alloy article, such as an aluminum alloy plate, an aluminum alloy shate, or an aluminum alloy sheet. Optionally, the rolled aluminum alloy product 112 is subjected to additional processing steps, as described below, to form an aluminum alloy article.

Non-limiting examples of casting processes include a direct chill (DC) casting process or a continuous casting (CC) process. For example, FIG. 1 depicts a schematic illustration of a DC casting process at 105, but other casting processes can be used. A continuous casting system can include a pair of moving opposed casting surfaces (e.g., moving opposed belts, rolls or blocks), a casting cavity between the pair of moving opposed casting surfaces, and a molten metal injector. The molten metal injector can have an end opening from which molten metal can exit the molten metal injector and be injected into the casting cavity.

A cast aluminum alloy product, such as a cast ingot, cast slab, or other cast product, can be processed by any desirable techniques. Optionally, the processing steps can be used to prepare rolled aluminum alloy products, such as aluminum alloy sheets. Example optional processing steps include, but are not limited to, homogenization, hot rolling, cold rolling, annealing, solution heat treatment, and pre-aging.

In a homogenization step, a cast product may be heated to a temperature ranging from about 400° C. to about 600° C. For example, the cast product can be heated to a temperature of about 400° C., about 410° C., about 420° C., about 430° C., about 440° C., about 450° C., about 460° C., about 470° C., about 480° C., about 490° C., about 500° C., about 510° C., about 520° C., about 530° C., about 540° C., about 550° C., about 560° C., about 570° C., about 580° C., about 590° C., or about 600° C. The product may then be allowed to soak (i.e., held at the indicated temperature) for a period of time to form a homogenized product. In some examples, the total time for the homogenization step, including the heating and soaking phases, can be up to 24 hours. For example, the product can be heated up to 500° C. to 600° C., and soaked, for a total time of up to 18 hours for the homogenization step. Optionally, the product can be heated to below 490° C. and soaked, for a total time of greater than 18 hours for the homogenization step. In some cases, the homogenization step comprises multiple processes. In some non-limiting examples, the homogenization step includes heating a cast product to a first temperature for a first period of time followed by heating to a second temperature for a second period of time. For example, a cast product can be heated to about 465° C. for about 3.5 hours and then heated to about 480° C. for about 6 hours.

Following a homogenization step, a hot rolling step can be optionally performed. Prior to the start of hot rolling, the homogenized product can be allowed to cool to a temperature between 300° C. to 450° C. For example, the homogenized product can be allowed to cool to a temperature of between 325° C. to 425° C. or from 350° C. to 400° C. The homogenized product can then be hot rolled at a temperature between 300° C. to 450° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between).

Optionally, the cast product can be a continuously cast product that can be allowed to cool to a temperature between 300° C. to 450° C. For example, the continuously cast product can be allowed to cool to a temperature of between 325° C. to 425° C. or from 350° C. to 400° C. The continuously cast products can then be hot rolled at a temperature between 300° C. to 450° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between). During hot rolling, temperatures and other operating parameters can be controlled so that the temperature of the hot rolled intermediate product upon exit from the hot rolling mill is no more than 470° C., no more than 450° C., no more than 440° C., or no more than 430° C.

Cast, homogenized, or hot-rolled products can be optionally cold rolled using cold rolling mills into thinner products, such as a cold rolled sheet or foil. The cold rolled product can optionally have a gauge between about 0.5 to 10 mm, e.g., between about 0.7 to 6.5 mm. Optionally, the cold rolled product can have a gauge of 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm. The cold rolling can be performed to result in a final gauge thickness that represents a gauge reduction of up to 85% (e.g., up to 10%, up to 20%, up to 30%, up to 40%, up to 50%, up to 60%, up to 70%, up to 80%, or up to 85% reduction) as compared to a gauge prior to the start of cold rolling. In the case of foils, cold rolling can be performed to a final thickness of the foil, such as less than 0.2 mm. Optionally, an interannealing step can be performed during the cold rolling step, such as where a first cold rolling process is applied, followed by an annealing process (interannealing), followed by a second cold rolling process. The interannealing step can be performed at a temperature of from about 300° C. to about 450° C. (e.g., about 310° C., about 320° C., about 330° C., about 340° C., about 350° C., about 360° C., about 370° C., about 380° C., about 390° C., about 400° C., about 410° C., about 420° C., about 430° C., about 440° C., or about 450° C.). In some cases, the interannealing step comprises multiple processes. In some non-limiting examples, the interannealing step includes heating the partially cold rolled product to a first temperature for a first period of time followed by heating to a second temperature for a second period of time. For example, the partially cold rolled product can be heated to about 410° C. for about 1 hour and then heated to about 330° C. for about 2 hours.

Subsequently, a cast, homogenized, or rolled product can optionally undergo a solution heat treatment step. The solution heat treatment step can be any suitable treatment for the product that results in solutionizing of soluble particles. The cast, homogenized, or rolled product can be heated to a peak metal temperature (PMT) of up to 590° C. (e.g., from 400° C. to 590° C.) and soaked for a period of time at the PMT to form a hot product. For example, the cast, homogenized, or rolled product can be soaked at 480° C. for a soak time of up to 30 minutes (e.g., 0 seconds, 60 seconds, 75 seconds, 90 seconds, 5 minutes, 10 minutes, 20 minutes, 25 minutes, or 30 minutes). After heating and soaking, the hot product is rapidly cooled at rates greater than 200° C./s to a temperature between 500 and 200° C. to form a heat-treated product. In one example, the hot product is cooled at a quench rate of above 200° C./second at temperatures between 450° C. and 200° C. Optionally, the cooling rates can be faster in other cases. Optionally, the temperature can be lower in other cases. In one example, the hot product is cooled at a quench rate of above 200° C./second at temperatures between 450° C. and 200° C.

After quenching, the heat-treated product can optionally undergo a pre-aging treatment by reheating before coiling. The pre-aging treatment can be performed at a temperature of from about 70° C. to about 125° C. for a period of time of up to 6 hours. For example, the pre-aging treatment can be performed at a temperature of about 70° C., about 75° C., about 80° C., about 85° C., about 90° C., about 95° C., about 100° C., about 105° C., about 110° C., about 115° C., about 120° C., or about 125° C. Optionally, the pre-aging treatment can be performed for about 30 minutes, about 1 hour, about 2 hours, about 3 hours, about 4 hours, about 5 hours, or about 6 hours. The pre-aging treatment can be carried out by passing the heat-treated product through a heating device, such as a device that emits radiant heat, convective heat, induction heat, infrared heat, or the like.

The cast products described herein can be used to make products in the form of sheets (including foils), plates, or other suitable products. For example, plates including the products as described herein can be prepared by processing an ingot in a homogenization step or casting a product in a continuous caster followed by a hot rolling step. In the hot rolling step, the cast product can be hot rolled to a 200 mm thick gauge or less (e.g., from about 10 mm to about 200 mm). For example, the cast product can be hot rolled to a plate having a final gauge thickness of about 10 mm to about 175 mm, about 15 mm to about 150 mm, about 20 mm to about 125 mm, about 25 mm to about 100 mm, about 30 mm to about 75 mm, or about 35 mm to about 50 mm. In some cases, plates may be rolled into thinner metal products, such as sheets or foils.

Other techniques beyond casting and rolling can be used for preparing aluminum alloy or other metal products, such as foils. In some examples, powder-based sintering or melting processes can be used, optionally in concert with rolling or other treatment processes. In some examples, metal products can be prepared using selective laser melting, direct metal laser sintering, laser powder bed fusion or other additive manufacturing techniques. In some examples, a metal product prepared by a powder-based, additive manufacturing, or composite engineering process can be subjected to rolling to at least partially consolidate and/or make a foil from the metal product.

### Example Metals and Metal Alloys

Described herein are methods of preparing, and using metals and metal alloys, including aluminum, aluminum alloys, among others, the resultant metals and metal alloys, and devices incorporating the metals and metal alloys. In some examples, the metals for use in the methods and devices described herein include aluminum alloys, for example, 1xxx series aluminum alloys, 2xxx series aluminum alloys, 3xxx series aluminum alloys, 4xxx series aluminum alloys, 5xxx series aluminum alloys, 6xxx series aluminum alloys, 7xxx series aluminum alloys, or 8xxx series aluminum alloys. In some examples, the materials for use in the methods described herein include non-ferrous materials, including aluminum, aluminum alloys, and aluminum-based composites, such as including aluminum and non-aluminum components, such as silicon, tin, indium, gallium, antimony, lead, nickel, copper, zinc, carbon, germanium, silver, etc. In some examples, aluminum alloys containing iron are useful with the methods and devices described herein.

By way of non-limiting example, exemplary 1xxx series aluminum alloys for use in the methods and devices described herein can include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199.

Non-limiting exemplary 2xxx series aluminum alloys for use in the methods and devices described herein can include AA2001, A2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting exemplary 3xxx series aluminum alloys for use in the methods and devices described herein can include AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Non-limiting exemplary 4xxx series aluminum alloys for use in the methods and devices described herein can include AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA4147.

Non-limiting exemplary 5xxx series aluminum alloys for use in the methods and devices described herein product can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting exemplary 6xxx series aluminum alloys for use in the methods and devices described herein can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, A6963, AA6064, AA6064A, AA6065, AA6066, AA6068, AA6069, AA6070, AA6081, AA6181, AA6181A, AA6082, AA6082A, AA6182, AA6091, or AA6092.

Non-limiting exemplary 7xxx series aluminum alloys for use in the methods and devices described herein can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, AA7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

Non-limiting exemplary 8xxx series aluminum alloys for use in the methods and devices described herein can include AA8005, AA8006, AA8007, AA8008, AA8010, AA8011, AA8011A, AA8111, AA8211, AA8112, AA8014, AA8015, AA8016, AA8017, AA8018, AA8019, AA8021, AA8021A, AA8021B, AA8022, AA8023, AA8024, AA8025, AA8026, AA8030, AA8130, AA8040, AA8050, AA8150, AA8076, AA8076A, AA8176, AA8077, AA8177, AA8079, AA8090, AA8091, or AA8093.

### Methods of Using the Disclosed Aluminum Alloy Products

The aluminum alloy products described herein can be used in battery applications. For example, the disclosed aluminum alloy products can be used as current collectors and/or electrode materials for batteries or electrochemical cells.

The aluminum alloy products and methods described herein can also be used in other electronics applications. For example, the aluminum alloy products and methods described herein can be used to prepare housings for electronic devices, including batteries. In some examples, the aluminum alloy products can be used to prepare housings for the outer casing of mobile phones (e.g., smart phones), tablet bottom chassis, single and multi-cell batteries, and other portable electronics.

As described above, solid-state electrochemical cells incorporating a solid-state electrolyte can advantageously incorporate aluminum materials as the anode active material. As an alloying electrode, aluminum can exhibit higher energy storage densities than commonly used anode materials for lithium-ion batteries, such as graphite, due to the higher storage potential of aluminum for lithium than graphite. Although the storage capability of aluminum may not be as high as metallic lithium, aluminum alloying anodes do not suffer from dendrite formation and thus provide safer operation of rechargeable or secondary batteries as compared to lithium metal batteries.

Additionally, avoiding use of graphite as the anode materials can not only increase anode storage capacity, but can limit the use of wet processing, since aluminum-based alloying anodes can be incorporated as a film or foil of material and do not have to be slurry deposited onto a current collector. In some cases, the aluminum-based alloying anodes can allow use as an anode material without a current collector, though conventional anode current collectors, such as copper foils, can also be used. In some cases, current collectors may comprise aluminum foils, such as an aluminum foil that is different from the active material of the anode. In some examples, protected aluminum foils can be used as an anode current collector, such as described in International Application Publication No. WO 2021/184035, hereby incorporated by reference.

Incorporation of aluminum-based materials as the active material in a solid-state electrochemical cell can also allow for incorporation of recycled content material directly in the electrode of an electrochemical cell. For example, the anode active material of the solid-state electrochemical cells described herein can comprise aluminum alloys incorporating high amounts of recycled content, such as up to 10%, up to 20%, up to 30%, up to 40%, or more.

Use of solid-state electrolyte components can further enhance safety, manufacturability, and other characteristics of a battery system. Lithium-ion batteries generally incorporate liquid organic solvents in the electrolytes, such as carbonate solvents. Such solvents are generally flammable and undergo undesirable side reactions at surfaces of the anode active materials at the potentials involved. These side reactions can form a solid electrolyte interphase (SEI) layer that degrades performance and reduces capacity.

The use of liquid electrolytes together with aluminum-based active materials can exacerbate the formation of SEI layers, as aluminum-based active materials undergo volumetric changes when they uptake or release lithium-ions. As the active materials uptake lithium, the active material expands, disturbing any SEI material on the surface of the active material and exposing fresh active material to the liquid electrolyte, which can undergo further react at the exposed active material and form additional SEI material. In this way, liquid electrolytes used with aluminum-based active materials can permit a buildup of SEI material above the active material.

However, when a solid-state electrolyte is used, such buildup of SEI material may not occur. For example, solid-state electrolytes may comprise solid materials, such as ceramic type sulfate materials like lithium argyrodite materials (e.g., Li₆PS₅Cl), which do not flow like liquid electrolytes. When such solid-state electrolytes encounter volumetric expansion of the anode active material through uptake of lithium, the solid-state electrolyte cannot flow to enter cracks and interfaces of exposed fresh active material, limiting the formation of SEI materials.

A pressure can be applied between a solid-state electrolyte and an aluminum-based active anode material to ensure that good electrical and ionic communication is maintained during charging or discharging and to account for volumetric contraction or expansion by release or uptake of lithium atoms or ions. Such pressure can be applied as a stack pressure between the anode and the cathode, with the solid-state electrolyte between them. The stack pressure can be applied through a casing or other components. Example stack pressures may range from 0.1 MPa to 30 MPa.

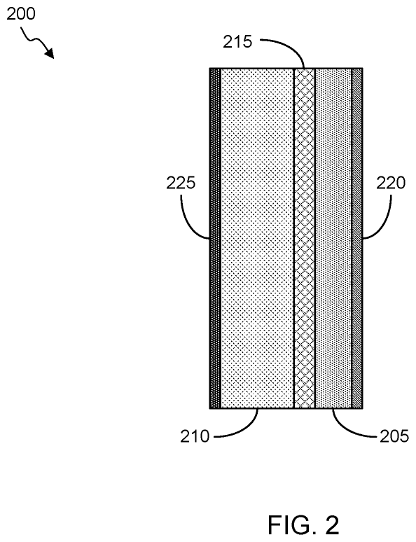

FIG. 2 provides a schematic illustration of an example solid-state electrochemical cell 200, comprising an anode active material 205, a cathode active material 210, a solid-state electrolyte 215, an anode current collector 220, and a cathode current collector 225. In conventional lithium-ion battery systems, the cathode current collector comprises a high purity aluminum foil, the cathode active material comprises a lithium metal oxide, a porous non-conductive material soaked with a liquid electrolyte comprising an organic solvent and a lithium salt is positioned between the anode active material and the cathode active material, the anode active material comprises graphite, and the anode current collector comprises copper foil. Certain of these materials may be used with the solid-state electrochemical cell, but others may not be used, such as a liquid electrolyte.

For example, the cathode active material 210 and cathode current collector 225 may incorporate materials used in conventional battery systems. Optionally, the cathode current collector 225 may comprise aluminum, such as in the form of an aluminum alloy foil. In some cases, cathode current collector 225 may comprise a high purity aluminum alloy, such as comprising 99.00 wt. % Al or more. Use of high purity aluminum alloys is useful for maintaining the electrical conductivity of the cathode current collector 225 at as high a level as possible. The cathode active material 210 may comprise any suitable cathode active material including but not limited to, alkali metal host materials or alkali metal-transition metal oxide cathode active materials, such as lithium nickel manganese cobalt oxide, lithium nickel cobalt aluminum oxide, lithium manganese oxide, lithium iron phosphate, or lithium metal cobalt oxide.

The anode active material 205 may comprise an alkali metal alloying anode, for example. Lithium can alloy with aluminum at potentials encountered at the anode, where lithium ions can be reduced and incorporated into the bulk of the aluminum material as an alloy during charging. During discharging, lithium can be oxidized and released from an alkali metal alloying anode as lithium ions. The aluminum used for the anode active material 205 can be a foil, such as a foil that comprises aluminum or an aluminum alloy, optionally as a composite or mixed metal foil, such as comprising one or more other metals or semiconductors like silicon, tin, indium, gallium, antimony, lead, nickel, copper, zinc, carbon, germanium, silver, or the like, optionally in amounts up to 50 mol. %. As described herein, foils can be processed using metal casting and rolling processes, but other techniques can be used to prepare foils including powder-based sintering or laser melting processes, such as laser powder bed fusion techniques. The anode active material may exhibit a specific capacity of from about 300 mAh/g to about 1000 mAh/g or more, such as from 300 mAh/g to 350 mAh/g, from 400 mAh/g to 450 mAh/g, from 450 mAh/g to 500 mAh/g, from 500 mAh/g to 550 mAh/g, from 550 mAh/g to 600 mAh/g, from 600 mAh/g to 650 mAh/g, from 650 mAh/g to 700 mAh/g, from 700 mAh/g to 750 mAh/g, from 750 mAh/g to 800 mAh/g, from 800 mAh/g to 850 mAh/g, from 850 mAh/g to 900 mAh/g, from 900 mAh/g to 950 mAh/g, or from 950 mAh/g to 1000 mAh/g. In some examples, the specific capacity may be higher still, such as if other components with higher specific capacities are included in the anode active material, such as silicon.

The anode active material 205 may comprise aluminum alloys or multi-component systems, such as eutectic alloys, solid solution alloys, mixed metal systems, or composite particle systems. In some examples, anode active material 205 may comprise a multi-component foil comprising aluminum and one or more of silicon, tin, indium, gallium, antimony, lead, nickel, copper, carbon, germanium, zinc, or silver. In some examples, the amount of aluminum in the anode active material 205 may be from about 40 wt. % to about 100 wt. % aluminum, such as from 40 wt. % to 45 wt. %, from 45 wt. % to 50 wt. %, from 50 wt. % to 55 wt. %, from 55 wt. % to 60 wt. %, from 60 wt. % to 65 wt. %, from 65 wt. % to 70 wt. %, from 70 wt. % to 75 wt. %, from 75 wt. % to 80 wt. %, from 80 wt. % to 85 wt. %, from 85 wt. % to 90 wt. %, from 90 wt. % to 95 wt. %, from 95 wt. % to 99 wt. %, from 99 wt. % to 99.9 wt. %, or 99.9 wt. % to 99.99 wt. %. In some examples, the amount of a non-aluminum element, such as one or more of silicon, tin, indium, gallium, antimony, lead, nickel, copper, carbon, germanium, zinc, or silver, may be from about 0.1 wt. % to about 60 wt. %, or less than or about 1 wt. %, such as from 0.1 wt. % to 0.5 wt. %, from 0.5 wt. % to 1 wt. % to 2 wt. %, from 2 wt. % to 5 wt. %, from 5 wt. % to 10 wt. %, from 10 wt. % to 15 wt. %, from 15 wt. % to 20 wt. %, from 20 wt. % to 25 wt. %, from 25 wt. % to 30 wt. %, from 30 wt. % to 35 wt. %, from 35 wt. % to 40 wt. %, from 40 wt. % to 45 wt. %, from 45 wt. % to 50 wt. %, from 50 wt. % to 55 wt. %, or from 55 wt. % to 60 wt. %. In some examples, anode active material 205 may comprise a composite including a first plurality of aluminum or aluminum alloy particles and a second plurality of particles selected from at least one of metal particles or non-metal particles. Additional details on composite anodes may be found in U.S. Provisional Application No. 63/261,216, hereby incorporated by reference.

The anode current collector 220 may comprise any suitable material, such as copper or other conductive materials, like aluminum. Copper can be beneficial for use as anode current collector 220, as copper is non-reactive at the potentials involved in lithium battery systems and exhibits high electrical conductivity. Aluminum can alloy with lithium at the potentials involved, making it useful as the anode active material 205, but such characteristics may not be desirable for use of aluminum as anode current collector 220. In some examples, however, aluminum may be used as anode current collector 220, as aluminum is also a highly conductive material and can be constructed as a foil. Optionally, when anode active material 205 comprises a metal foil, anode current collector 220 may not be used, as electrical connections can instead be established directly with anode active material 205 to provide conduction of electrons to/from external circuits (e.g., a load or a power supply). In some cases, aluminum may be used as anode current collector 220 in the form of a protected aluminum foil.

Anode current collector 220 may also be made to have an engineered structure. By engineering the structure, the structure may include additional space and micro-porosity. Without being bound by theory, such additional space and/or micro-porosity may compensate for volume changes within the anode current collector 220. Various methods may be used to form this engineered structure, including powder metallurgy, forming a micro-porous or nano-porous structure by additive manufacturing, using metallic foams, forming perforations by laser or deep etching, de-alloying (e.g., chemical de-alloying), or other methods. In some examples, an engineered structure may be processed by rolling, such as to at least partially consolidate or otherwise make a foil from the engineered structure. In some examples, an engineered structure may comprise or be coupled to, joined to, or bonded to a solid aluminum-based or aluminum alloy-based structure (e.g., a foil) as a solid base layer. In some examples, an engineered structure may be coupled to, joined to, or bonded to a current collector, for example a foil-based current collector, such as a copper current collector or a protected or coated aluminum or aluminum alloy current collector (e.g., an aluminum or aluminum foil coated with Fe, TiN, Ni, or the like). Examples of aluminum-based current collectors, including protected or coated aluminum current collectors, are described in PCT International Application No. PCT/US2021/070250, which is hereby incorporated by reference.

Any suitable solid-state electrolyte 215 may be used in solid-state electrochemical cell 200. For example, solid-state electrolyte 215 may comprise an ion conducting and electrically insulating material, such as an inorganic solid electrolyte. In some cases, solid-state electrolyte 215 may comprise a solid polymer electrolyte, a composite polymer electrolyte, a polymer-gel electrolyte, or a gel electrolyte, though in some examples, the solid-state electrolyte 215 explicitly comprises an inorganic solid electrolyte and not a solid polymer electrolyte, composite polymer electrolyte, or gel electrolyte. Inorganic solid electrolytes include, but are not limited to, crystalline, glassy, or ceramic ion conducting materials (e.g., alkali metal ion conducting materials). Example solid-state electrolytes include, but are not limited to, those comprising one or more of lithium super ionic conductors (LISICON), argyrodite materials, (e.g., Li₆PS₅Cl), doped garnet materials, (e.g., Li₇La₃Zr₂O₁₂, LLZO), Li₁₀GeP₂S₁₂ and related materials, such as Li₁₀SnP₂S₁₂, lithium phosphorus sulfide (e.g., Li₃PS₄), or lithium phosphorus oxynitride (LIPON). Suitable materials for solid-state electrolyte 215 may exhibit an ionic conductivity for alkali metal ions of greater than or about 10⁻⁴ S/cm (e.g., from 10⁻⁴ S/cm to 0.01 S/cm).

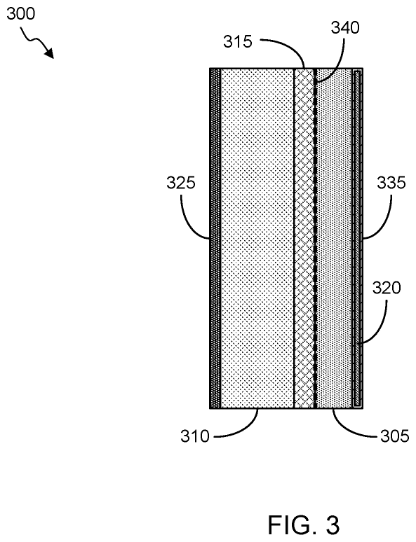

FIG. 3 provides a schematic illustration of another solid-state electrochemical cell 300. Solid-state electrochemical cell 300 may include similar or identical components to solid-state electrochemical cell 300. For example, solid-state electrochemical cell 300 may comprise an anode active material 305, a cathode active material 310, a solid-state electrolyte 315, an anode current collector 320, and a cathode current collector 325. Such components may comprise the same materials as described above.

Solid-state electrochemical cell 300 further comprises a protective coating 335 surrounding the anode current collector 320. The use of protective coating 335 may allow for anode current collector 320 to comprise a material that alloys with alkali metals, such as aluminum, as a current collector without anode current collector 320 suffering deleterious effects that may arise during alloying. For example, protective coating 335 may comprise an electrically conductive material that blocks transmission of lithium atoms, allowing electrons to be conducted to anode current collector 320 while preventing lithium atoms from reaching and alloying with anode current collector 320. Example materials and configurations for protective coating 335 are described in International Application Publication No. WO 2021/184035. In one non-limiting example, protective coating 335 comprises an iron coating.

Solid-state electrochemical cell 300 further comprises an interface material 340 between the anode active material 305 and the solid-state electrolyte 315. In some examples, interface material 340 corresponds to a SEI layer, which may be formed during cycling of solid-state electrochemical cell 300, or an artificial SEI. In other examples, interface material 340 is another material positioned between the anode active material 305 and the solid-state electrolyte 315, such as a polymer coating, a carbon coating, or an inorganic coating. In some examples, interface material 340 can improve contact or provide for improved ion conductivity between the anode active material 305 and the solid-state electrolyte 315 and/or provide a buffer for uptake and/or release of lithium ions, for example. In some cases, interface material 340 can protect against formation of dendrites in the event that the anode active material 305 is driven to uptake lithium in excess of its alloying capacity.

Without limitation, any suitable dimensions for the anode active materials, anode current collectors, cathode active materials, cathode current collectors, solid-state electrolytes, interface materials, or protective coatings may be used. In some examples, a solid-state electrolyte may have a thickness of from about 10 μm to about 300 μm, such as from 10 μm to 20 μm, from 20 μm to 30 μm, from 30 μm to 40 μm, from 40 μm to 50 μm, from 50 μm to 75 μm, from 75 μm to 100 μm, from 100 μm to 125 μm, from 125 μm to 150 μm, from 150 μm to 175 μm, from 175 μm to 200 μm, from 200 μm to 250 μm, or from 250 μm to 300 μm. In some examples, an anode or an anode active material may have a thickness of from about 5 μm to about 60 μm, such as from 5 μm to 10 μm, from 10 μm to 15 μm, from 15 μm to 20 μm, from 20 μm to 25 μm, from 25 μm to 30 μm, from 30 μm to 35 μm, from 35 μm to 40 μm, from 40 μm to 45 μm, from 45 μm to 50 μm, from 50 μm to 55 μm, or from 55 μm to 60 μm.

The examples disclosed herein will serve to further illustrate aspects of the invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. The examples and embodiments described herein may also make use of conventional procedures, unless otherwise stated. Some of the procedures are described herein for illustrative purposes.

### Example 1

This Example describes details of comparative testing of electrochemical cells, including solid-state electrochemical cells incorporating an aluminum active anode material and a solid-state electrolyte and comparative cells incorporating an aluminum active anode material and a liquid electrolyte.

Solid-state electrochemical cells were prepared using a lithium nickel manganese cobalt oxide cathode of formula LiNi_{0.6}Mn_{0.2}Co_{0.2}O₂ (NMC-622) and an aluminum alloy-based anode. A Li₆PS₅Cl solid electrolyte was positioned between the cathode and the anode. As a reference cell, an identical aluminum alloy-based anode was assembled into as a half-cell battery with a liquid electrolyte, using a lithium metal counter electrode with a porous separator soaked with an electrolyte comprising 1.0 M lithium bis (fluorosulfonyl) imide (LiFSI) and 1.0 M lithium difluoro (oxalate) borate (LiDFOB) in a 3:7 by volume mixture of fluoroethylene carbonate:diethyl carbonate (FEC:DEC) between the aluminum alloy-based anode and the lithium metal counter electrode. The aluminum alloy-based anodes were approximately 30 μm thick and 1 cm in diameter, and they were either high-purity aluminum or an aluminum alloy with 6 atomic % of indium. The solid-state cells were cycled first at C/40 for two cycles, then at C/20 for three cycles, and then at C/10 for the remainder of the cycles. A stack pressure of approximately 24 MPa was applied to the solid-state cells.

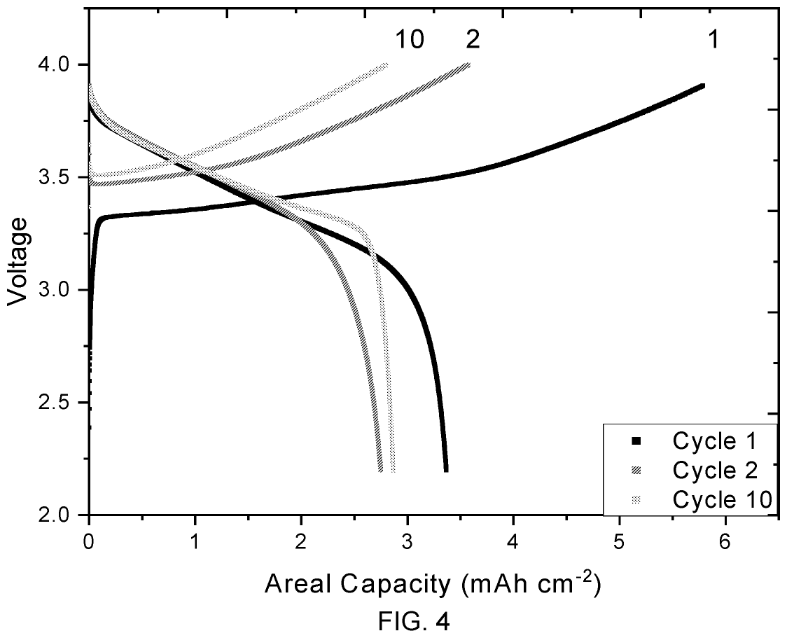

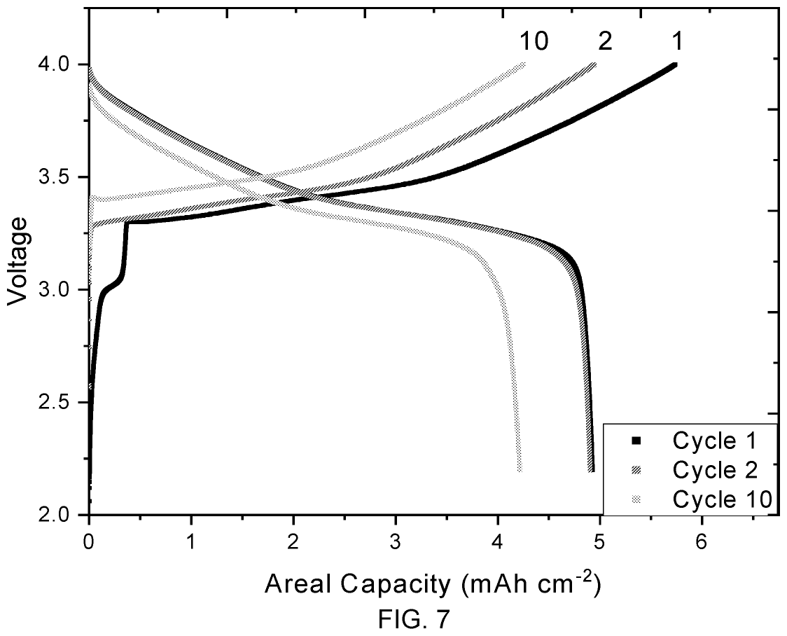

The solid-state cells were cycled between 2.2 V and 4.0 V and areal capacities (mAh cm⁻²) were monitored as a function of cycle number. The anode to cathode capacity ratio (N:P) was 1.44 for the solid-state cell in FIGS. 4 and 1.60 for the solid-state cell in FIG. 7. The reference half-cell was cycled and controlled to have 3.0 mAh cm⁻² areal capacity during each step of lithiating the aluminum alloy-based anode until the reference cell failed.

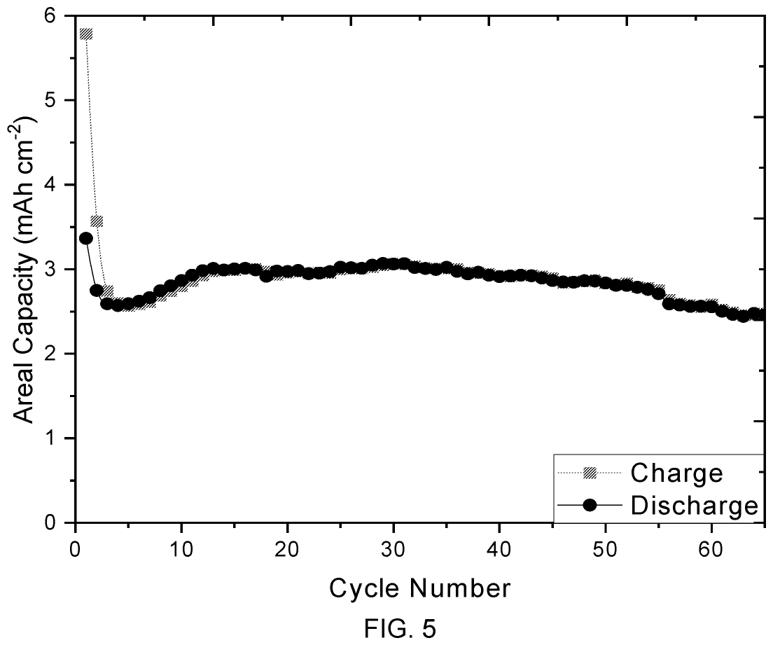

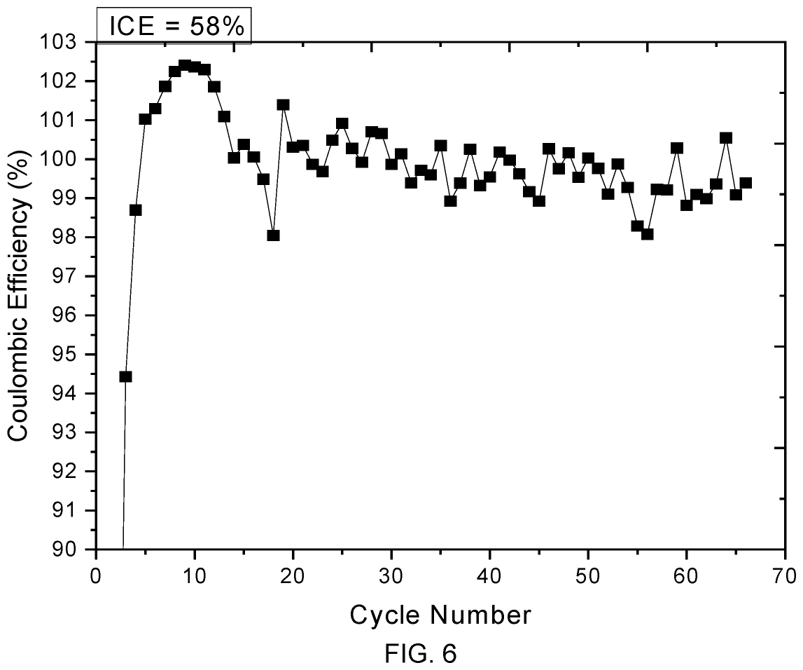

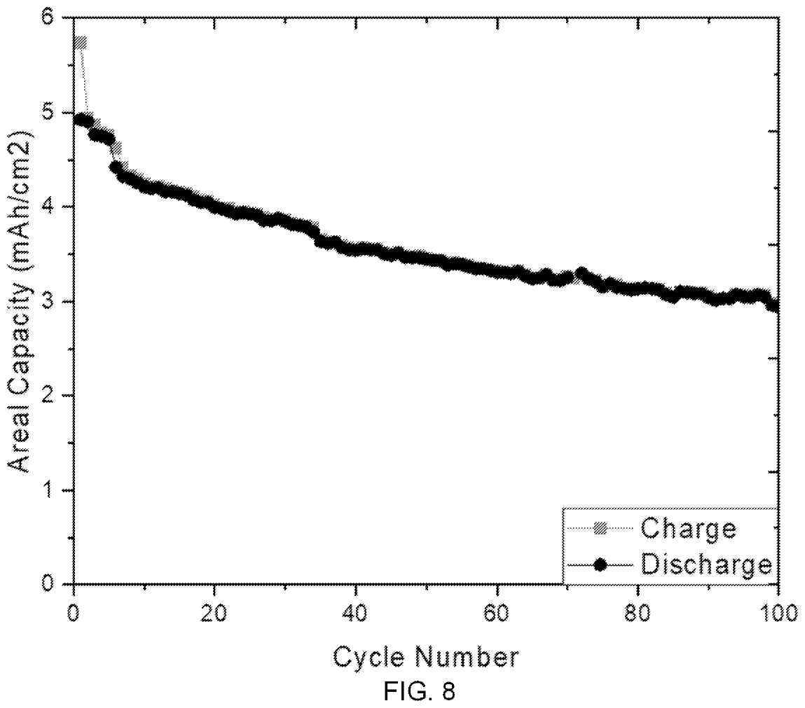

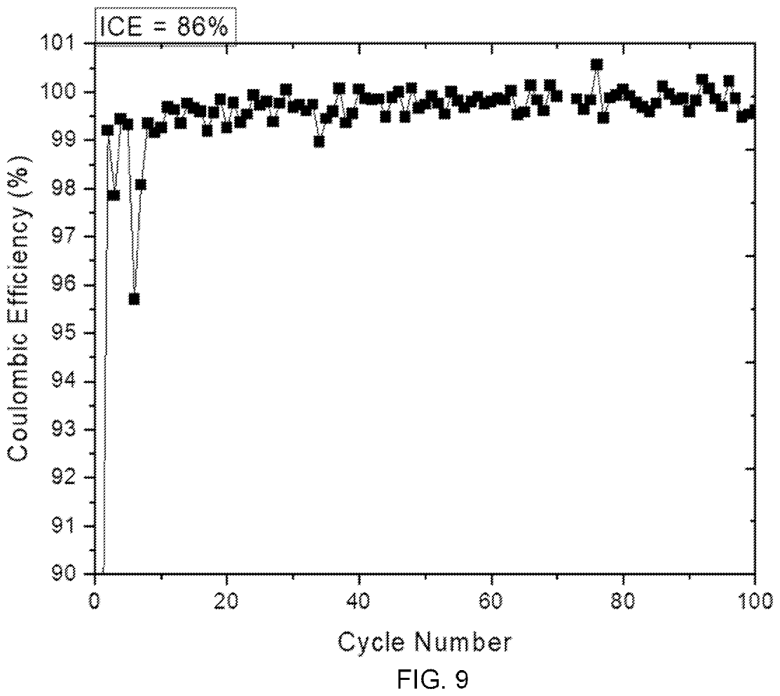

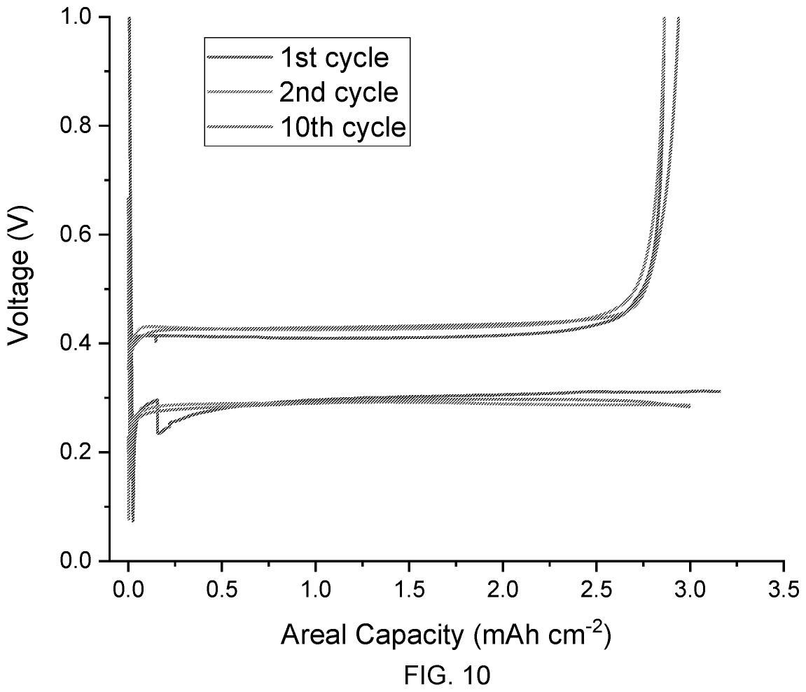

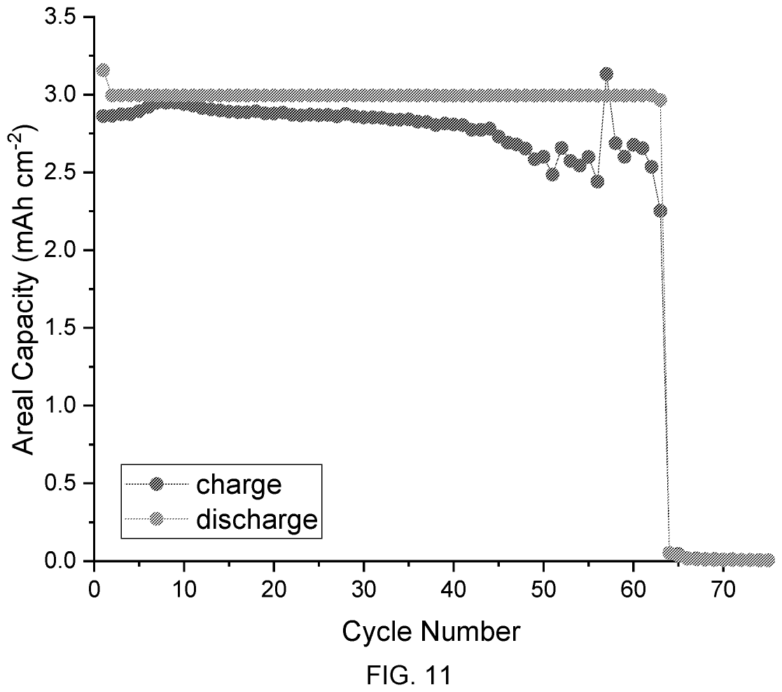

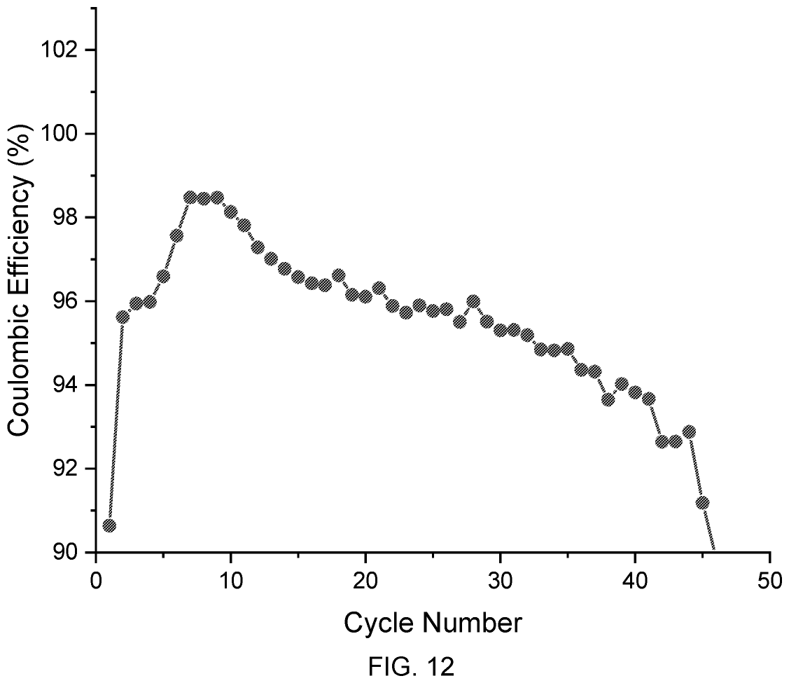

Voltage vs. capacity curves for the 1^{st}, 2^{nd}, and 10^{th} cycles are shown for two example solid-state electrochemical cells in FIGS. 4 and 7 and for the reference half-cell in FIG. 10. Plots of capacity vs. cycle number are shown for the two example solid-state electrochemical cells in FIGS. 5 and 8 and for the reference half-cell in FIG. 11. Plots of Coulombic Efficiency vs. cycle number are shown for the two example solid-state electrochemical cells in FIGS. 6 and 9 and for the reference half-cell in FIG. 12. As indicated in FIGS. 6 and 9, the example solid-state electrochemical cells showed an initial Coulombic efficiency (ICE) for the first cycle of 58% and 86%. The reference half-cell showed an initial Coulombic efficiency (ICE) for the first cycle of about 91%.

The example solid-state electrochemical cells showed very high Coulombic efficiency as compared to the reference half-cell, with Columbic efficiency for the solid-state electrochemical cells generally above 97% (and above 99% after 10 cycles for one of the solid-state cells), while the reference half-cell saw a peak occurring at around 8 or 10 cycles, followed by a steady decline until about 45 cycles where a dramatic decrease was observed.

### Illustrative Aspects

As used below, any reference to a series of aspects (e.g., “Aspects 1-4”) or non-enumerated group of aspects (e.g., “any previous or subsequent aspect”) is to be understood as a reference to each of those aspects disjunctively (e.g., “Aspects 1-4” is to be understood as “Aspects 1, 2, 3, or 4”).

Aspect 1 is a solid-state battery, comprising: an anode, the anode comprising aluminum as an anode active material; a cathode; and a solid-state electrolyte between the anode and the cathode.

Aspect 2 is the solid-state battery of any previous or subsequent aspect, wherein the anode comprises an aluminum-based alkali metal alloying anode.

Aspect 3 is the solid-state battery of any previous or subsequent aspect, wherein the alkali metal is lithium.

Aspect 4 is the solid-state battery of any previous or subsequent aspect, wherein the anode comprises an aluminum alloy or a recycled-content aluminum alloy.

Aspect 5 is the solid-state battery of any previous or subsequent aspect, wherein the anode comprises an aluminum-based multi-component foil, the aluminum-based multi-component foil comprising aluminum and one or more of silicon, tin, indium, gallium, antimony, lead, nickel, copper, carbon, germanium, zinc, or silver.

Aspect 6 is the solid-state battery of any previous or subsequent aspect, wherein the anode comprises a foil including from 40 wt. % to 99 wt. % aluminum and from 30 wt. % to 60 wt. % of one or more of silicon, tin, indium, gallium, antimony, lead, nickel, copper, carbon, germanium, zinc, or silver.

Aspect 7 is the solid-state battery of any previous or subsequent aspect, wherein the anode has a thickness of from 5 μm to 60 μm.

Aspect 8 is the solid-state battery of any previous or subsequent aspect, wherein the anode exhibits a specific capacity of from 300 mAh/g to 1000 mAh/g.

Aspect 9 is the solid-state battery of any previous or subsequent aspect, wherein the anode comprises a composite foil including a first plurality of aluminum or aluminum alloy particles and a second plurality of particles selected from at least one of metal particles or non-metal particles.

Aspect 10 is the solid-state battery of any previous or subsequent aspect, wherein the solid-state electrolyte is an inorganic solid electrolyte.

Aspect 11 is the solid-state battery of any previous or subsequent aspect, wherein the solid-state electrolyte comprises a lithium argyrodite material, Li₆PS₅Cl, a lithium super ionic conductor (LISICON), a doped garnet material, Li₇La₃Zr₂O₁₂ (LLZO), Li₁₀GeP₂S₁₂, Li₁₀SnP₂S₁₂, lithium phosphorus sulfide (Li₃PS₄), lithium phosphorus oxynitride (LIPON), a polymer solid electrolyte, or a gel-polymer electrolyte.

Aspect 12 is the solid-state battery of any previous or subsequent aspect, wherein the solid-state electrolyte has a thickness of from 10 μm to 300 μm.

Aspect 13 is the solid-state battery of any previous or subsequent aspect, wherein the cathode comprises an alkali metal host material or an alkali metal-transition metal oxide cathode active material.

Aspect 14 is the solid-state battery of any previous or subsequent aspect, wherein the cathode comprises lithium nickel manganese cobalt oxide, lithium nickel cobalt aluminum oxide, lithium manganese oxide, lithium iron phosphate, lithium cobalt oxide, conversion cathodes, FeS₂, FeF₃, sulfur-based cathodes, or sulfur.

Aspect 15 is the solid-state battery of any previous or subsequent aspect, further comprising one or more of: a cathode current collector in contact with the cathode; or an anode current collector in contact with the anode.

Aspect 16 is the solid-state battery of any previous or subsequent aspect, wherein the anode current collector comprises a protected aluminum alloy foil.

Aspect 17 is the solid-state battery of any previous or subsequent aspect, wherein a stack pressure is applied between the anode and the cathode, wherein the stack pressure is from 0.1 MPa to 30 MPa.

Aspect 18 is the solid-state battery of any previous or subsequent aspect, further comprising an interface material between the anode and the solid-state electrolyte.

Aspect 19 is the solid-state battery of any previous or subsequent aspect, wherein the interface material comprises a solid-electrolyte interphase, an artificial solid-electrolyte interphase, a polymer coating, a carbon coating, or an inorganic coating.

Aspect 20 is a method of making a solid-state battery, the method comprising: providing an anode, the anode comprising aluminum as an anode active material; providing a cathode; and positioning a solid-state electrolyte between the anode and the cathode.

Aspect 21 is the method of any previous or subsequent aspect, wherein providing the anode comprises: preparing an aluminum-based multi-component foil, the aluminum-based multi-component foil comprising aluminum and one or more of silicon, tin, indium, gallium, antimony, lead, nickel, copper, carbon, germanium, zinc, or silver.

Aspect 22 is the method of any previous or subsequent aspect, wherein preparing the aluminum-based multi-component foil comprises: casting an aluminum-based multi-component product comprising aluminum and one or more of silicon, tin, indium, gallium, antimony, lead, nickel, copper, carbon, germanium, zinc, or silver to create an aluminum-based multi-component product; and rolling the aluminum-based multi-component product into a foil.

Aspect 23 is the method of any previous or subsequent aspect, wherein preparing the aluminum-based multi-component foil comprises: obtaining a powder mixture of aluminum and one or more of silicon, tin, indium, gallium, antimony, lead, nickel, copper, carbon, germanium, zinc, or silver; and subjecting the powder mixture to a laser powder bed fusion process to create aluminum-based multi-component product.

Aspect 24 is the method of any previous or subsequent aspect, wherein preparing the aluminum-based multi-component foil comprises: accumulative roll bonding aluminum or an aluminum alloy and an amount of one or more of silicon, tin, indium, gallium, antimony, lead, nickel, copper, carbon, germanium, zinc, or silver to create aluminum-based multi-component product.

Aspect 25 is the method of any previous or subsequent aspect, wherein preparing the aluminum-based multi-component foil comprises: forming a micro-porous or nano-porous aluminum-based multi-component product using powder metallurgy, additive manufacturing, metallic foams, forming perforations by laser or deep etching, or de-alloying.

Aspect 26 is the method of any previous aspect, wherein preparing the aluminum-based multi-component foil further comprises: rolling the aluminum-based multi-component product into a foil.

Aspect 27 is the method of any previous or subsequent aspect, further comprising one or more of: contacting the anode with an anode current collector; or contacting the cathode with a cathode current collector.

Aspect 28 is the method of any previous aspect, wherein the solid-state battery comprises the solid-state battery of any previous aspect.

All patents and publications cited herein are incorporated by reference in their entirety. The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

1. A solid-state battery, comprising:
an anode, the anode comprising aluminum as an anode active material;
a cathode; and
a solid-state electrolyte between the anode and the cathode.

2. The solid-state battery of claim 1, wherein the anode comprises an aluminum-based alkali metal alloying anode.

3. The solid-state battery of claim 2, wherein the alkali metal is lithium.

4. The solid-state battery of claim 1, wherein the anode comprises an aluminum alloy, a recycled-content aluminum alloy, or an aluminum brazing alloy.

5. The solid-state battery of claim 1, wherein the anode comprises an aluminum-based multi-component foil, the aluminum-based multi-component foil comprising aluminum and one or more of silicon, tin, indium, gallium, antimony, lead, nickel, copper, carbon, germanium, zinc, or silver.

6. The solid-state battery of claim 1, wherein the anode comprises a foil including from 40 wt. % to 99 wt. % aluminum and from 30 wt. % to 60 wt. % of one or more of silicon, tin, indium, gallium, antimony, lead, nickel, copper, carbon, germanium, zinc, or silver.

7. The solid-state battery of claim 1, wherein the anode has a thickness of from 5 μm to 60 μm.

8. The solid-state battery of claim 1, wherein the anode exhibits a specific capacity of from 300 mAh/g to 1000 mAh/g.

9. The solid-state battery of claim 1, wherein the anode comprises a composite foil including a first plurality of aluminum or aluminum alloy particles and a second plurality of particles selected from at least one of metal particles or non-metal particles.

10. The solid-state battery of claim 1, wherein the solid-state electrolyte is an inorganic solid electrolyte.

11. The solid-state battery of claim 1, wherein the solid-state electrolyte comprises a lithium argyrodite material, Li₆PS₅Cl, a lithium super ionic conductor (LISICON), a doped garnet material, Li₇La₃Zr₂O₁₂ (LLZO), Li₁₀GeP₂S₁₂, Li₁₀SnP₂S₁₂, lithium phosphorus sulfide (Li₃PS₄), lithium phosphorus oxynitride (LIPON), a polymer solid electrolyte, or a gel-polymer electrolyte.

12. The solid-state battery of claim 1, wherein the solid-state electrolyte has a thickness of from 10 μm to 300 μm.

13. The solid-state battery of claim 1, wherein the cathode comprises an alkali metal host material or an alkali metal-transition metal oxide cathode active material.

14. The solid-state battery of claim 1, wherein the cathode comprises lithium nickel manganese cobalt oxide, lithium nickel cobalt aluminum oxide, lithium manganese oxide, lithium iron phosphate, lithium cobalt oxide, conversion cathodes, FeS₂, FeF₃, sulfur-based cathodes, or sulfur.

15. The solid-state battery of claim 1, further comprising one or more of:
a cathode current collector in contact with the cathode; or
an anode current collector in contact with the anode.

16. The solid-state battery of claim 15, wherein the anode current collector comprises a protected aluminum alloy foil.

17. The solid-state battery of claim 1, wherein a stack pressure is applied between the anode and the cathode, wherein the stack pressure is from 0.1 MPa to 30 MPa.

18. The solid-state battery of claim 1, further comprising an interface material between the anode and the solid-state electrolyte.

19. The solid-state battery of claim 1, wherein the interface material comprises a solid-electrolyte interphase, an artificial solid-electrolyte interphase, a polymer coating, a carbon coating, or an inorganic coating.

20. A method of making a solid-state battery, the method comprising:
providing an anode, the anode comprising aluminum as an anode active material;
providing a cathode; and
positioning a solid-state electrolyte between the anode and the cathode.

21-28. (canceled)
